(19) United States
(12) Patent Application Publication
(10) Pub. No.: US 2011/0248928 A1
(43) Pub. Date: Oct. 13, 2011

(54) DEVICE AND METHOD FOR GESTURAL OPERATION OF CONTEXT MENUS ON A TOUCH-SENSITIVE DISPLAY

(75) Inventor: Jeyprakash Michaelraj, San Jose, CA (US)

(73) Assignee: MOTOROLA, INC., Schaumburg, IL (US)

(21) Appl. No.: 12/756,680

(22) Filed: Apr. 8, 2010

(51) Int. Cl. G06F 3/041; G06F 3/048

(52) U.S. Cl. 345/173; 715/810

(57) ABSTRACT

There is described a portable electronic device and method for gestural operation of context menus. The portable electronic device comprises a touch-sensitive sensor, a display having the touch-sensitive sensor corresponding to at least a portion of the display, and a processor coupled to the touch-sensitive sensor. The display provides an activation image and a plurality of transient menu options arranged radially from the activation image in response to detecting a first activation at the touch-sensitive sensor. Each transient menu option corresponds to a distinct device action. The processor activates a device action corresponding to a particular transient menu option in response to detecting a second activation at the touch-sensitive sensor that corresponds to the particular transient menu option.

### FIELD OF THE INVENTION

The present invention relates generally to the field of portable electronic devices and, more particularly, to the field of a portable electronic device having a touch-sensitive display for facilitating user interaction.

### BACKGROUND OF THE INVENTION

A portable electronic device is capable of interacting with a user and transportable due to its diminutive size and portable power supply. An example of a portable electronic device is a wireless communication device, which provides long-range communication of voice or data over a communication network of specialized base stations to other communication devices remote from the wireless communication device. Portable electronic devices come in a variety of form factors, such as brick, bar, flip/clamshell, slider or rotator/swivel form factors, and each form factor can have a touch-sensitive display or QWERTY keypad. Regardless of the small form factor, the device generally includes a display to convey information to a user or otherwise facilitate the user's use and enjoyment of the device.

Many user interfaces of portable electronic devices provide menu controls for access to user actions. For handheld and/or mobile devices, menus are often cumbersome and user-unfriendly. With the advent of touch-sensitive displays for portable electronic devices, this problem can be resolved by allowing users to interact directly with screen elements of the user interface. On the other hand, direct interaction with screen elements poses usability challenges as well as technical challenges.

For many computing devices, users interact with screen elements using an indirect input device, such as computer mouse. Based on the screen position, the traditional menus, such as contextual or pop-up menus, may pop-up on the screen. Contextual and pop-up menus do not solve usability and technical problems, because they are still linear menus (sometimes with scroll bars) requiring the user to perform multiple clicks or desire displays with substantial linear dimensions, thereby affecting the ease-of-use.

### BRIEF DESCRIPTION OF THE DRAWINGS

FIG. 1 is a perspective view of an example portable electronic device in accordance with the present invention.

FIG. 2 is a block diagram of example components of the portable electronic device of FIG. 1.

FIG. 3 is a screen view of a display of the portable electronic device illustrating a zoom out function.

FIG. 4 is a screen view of the display of the portable electronic device illustrating a result of the zoom out function of FIG. 3.

FIG. 5 is a screen view of the display of the portable electronic device illustrating a zoom in function.

FIG. 6 is a screen view of the display of the portable electronic device illustrating a result of the zoom in function of FIG. 5.

FIG. 7 is a screen view of the display of the portable electronic device illustrating a traffic off function.

FIG. 8 is a screen view of the display of the portable electronic device illustrating a result of the traffic off function of FIG. 7.

FIG. 9 is a screen view of the display of the portable electronic device illustrating a satellite off function.

FIG. 10 is a screen view of the display of the portable electronic device illustrating a result of the satellite off function of FIG. 9.

FIG. 11 is a flow diagram of an operation of the portable electronic device in accordance with the present invention.

### DETAILED DESCRIPTION OF THE EMBODIMENTS

There is described a user-friendly and manageable user interface of a portable electronic device for providing menu controls for access to user actions. As a user touches a surface of a touch screen corresponding to a display, a radially dispersed array of new transient menu options appear on the display, around the contact point at the surface of the touch screen. The user can drag his or her finger, i.e., continuously contact, from the contact point over one of these various new transient menu options. Each transient menu control that comes under the dragged finger may provide visual feedback to the user, and visual images of the transient menu options may be radially distributed about the contact point, thereby making it easier and quicker for a user to access them than a linear list. Also, transient menu options may occupy larger-than-usual screen real estate, thus utilizing non-textual descriptions such as pictures, icons, etc. In addition, this operation of arranging visual images radially and touching/dragging a finger radially outwards provides a wider spectrum of movement opportunities, i.e., up to 360 degree angle, and enables efficient use of screen real estate.

The above described radial gesture mode may be fast and efficient to use. A user may avoid searching through a linear list of menus, as may be required by other systems. Also, by mapping similar semantic operations of radial gestures, the radial gestures may be recorded in the muscle memory of the user. For example, one device action may be associated with a first radial gesture in one direction, whereas another device action may be associated with a second radial gesture in a different direction.

One aspect of the present invention is a portable electronic device for gestural operation of context menus. The portable electronic device comprises a touch-sensitive sensor, a display having the touch-sensitive sensor corresponding to at least a portion of the display, and a processor coupled to the touch-sensitive sensor. The display provides an activation image and a plurality of transient menu options arranged radially from the activation image in response to detecting a first activation at the touch-sensitive sensor. Each transient menu option corresponds to a distinct device action. The processor activates a device action corresponding to a particular transient menu option of the plurality of transient menu options in response to detecting a second activation at the touch-sensitive sensor that corresponds to the particular transient menu option.

Another aspect of the present invention is a method of the portable electronic device for gestural operation of context menus. The touch-sensitive sensor detects a first activation. The display provides an activation image and a plurality of transient menu options radially from the activation image. The touch-sensitive sensor detects a second activation that corresponds to a particular transient menu option of the plurality of transient menu options. The processor activates a device action corresponding to the particular transient menu option.

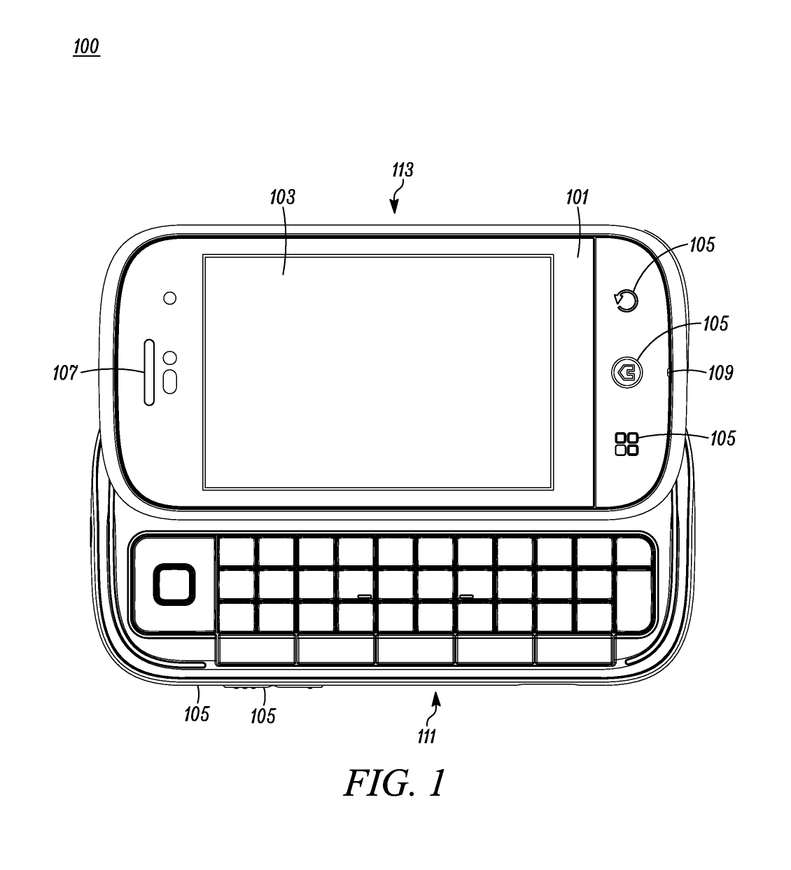

Referring to FIG. 1, there is illustrated a perspective view of an example portable electronic device 100 in accordance with the present invention. The device 100 may be any type of device capable of providing a visual representation of a transient menu option. Examples of the portable electronic device 100 include, but are not limited to, cellular-based mobile phones, WLAN-based mobile phones, personal digital assistants, personal navigation device, touch screen input device, pen-based input devices, portable video and/or audio players, and the like.

For one embodiment, the portable electronic device 100 has a housing comprising a front surface 101 which includes a visible display 103 and a user interface. For example, the user interface may be the touch-sensitive sensor at its surface that overlays the display 103. In particular, the touch-sensitive sensor may have a planar configuration and overlays at least a portion of the display. For another embodiment, the user interface of the portable electronic device 100 may include a touch-sensitive sensor supported by the housing and does not overlay any type of display. For yet another embodiment, the user interface of the portable electronic device 100 may include one or more input keys 105 used in conjunction with the touch-sensitive sensor. Examples of the input key or keys 105 include, but are not limited to, keys of an alpha or numeric keypad, a physical keys, touch-sensitive sensors, mechanical surfaces, multipoint directional keys and side buttons 105, 111. The portable electronic device 100 may also comprise apertures 107, 109 for audio output and input at the surface. It is to be understood that the portable electronic device 100 may include a variety of different combination of displays and interfaces.

It is to be understood that the portable electronic device 100 make take the form of a variety of form factors, such as bar, flip/clam, slider and rotator form factors. For example, for the embodiment shown in FIG. 1, the portable electronic device 100 may include a first housing 111 having an upper surface, a second housing 113 having a lower surface slidably coupled to the upper surface of the first housing. As represented in FIG. 1, the device 100 is shown in a closed position. The second housing 113 is capable of sliding to a closed position relative to the first housing in which upper and lower surfaces are substantially adjacent and concealed. The device 100 may also open to an open position. The second housing 113 is capable of sliding to an open position relative to the first housing 111 in which only a portion of the upper and lower surfaces are adjacent and concealed and the remainders of the upper and lower surfaces are offset and exposed. For another embodiment, the second housing may support a display, a first user interface, an audio input, and an audio output, and the first housing may support a second user interface and a wireless transceiver.

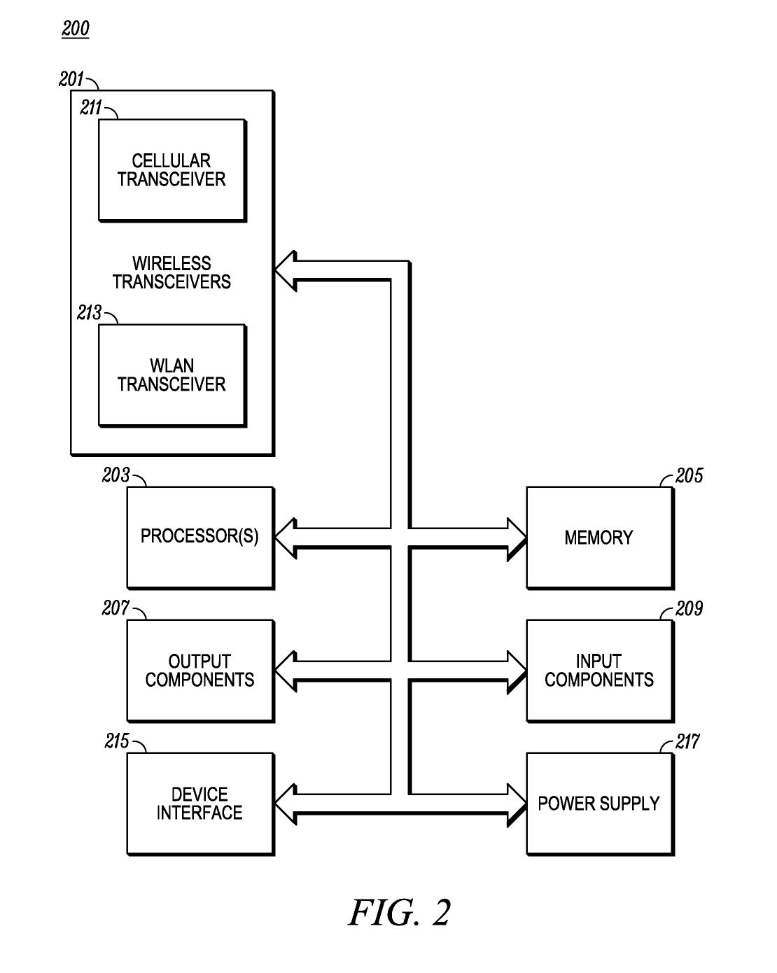

Referring to FIG. 2, there is shown a block diagram representing example components that may be used for an embodiment in accordance with the present invention. The example embodiment may includes one or more wireless transceivers 201, one or more processors 203, one or more memories 205, one or more output components 207, and one or more input components 209. Each embodiment may include a user interface that comprises one or more output components 207 and one or more input components 209. Each wireless transceiver 201 may utilize wireless technology for communication, such as, but are not limited to, cellular-based communications, as represented by 211, such as analog communications (using AMPS), digital communications (using CDMA, TDMA, GSM, iDEN, GPRS, or EDGE), and next generation communications (using UMTS, WCDMA, LTE, LTE-A or IEEE 802.16) and their variants, as represented by cellular transceiver 311. Each wireless transceiver 201 may also utilize wireless technology for communication, such as, but are not limited to, peer-to-peer or ad hoc communications such as HomeRF, Bluetooth and IEEE 802.11 (a, b, g or n); and other forms of wireless communication such as infrared technology, as represented by WLAN transceiver 213. Also, each transceiver 201 may be a receiver, a transmitter or both.

The processor 203 may generate commands based on information received from one or more input components 209. The processor 203 may process the received information alone or in combination with other data, such as the information stored in the memory 205. Thus, the memory 205 of the internal components 200 may be used by the processor 203 to store and retrieve data. The data that may be stored by the memory 205 include, but is not limited to, operating systems, applications, and data. Each operating system includes executable code that controls basic functions of the portable electronic device, such as interaction among the components of the internal components 200, communication with external devices via each transceiver 201 and/or the device interface (see below), and storage and retrieval of applications and data to and from the memory 205. Each application includes executable code utilizes an operating system to provide more specific functionality for the portable electronic device. Also, the processor is capable of executing an application or device action associated with a particular transient menu option shown at an output component 207. Data is non-executable code or information that may be referenced and/or manipulated by an operating system or application for performing functions of the portable electronic device.

The input components 209, such as a user interface, may produce an input signal in response to detecting a predetermined gesture at the touch-sensitive sensor. As a result, a transceiver 201 may terminate communication with the remote device in response to the input signal from the user interface. In addition, the input components 209 may include one or more additional components, such as a video input component such as an optical sensor (for example, a camera), an audio input component such as a microphone, and a mechanical input component or activator such as button or key selection sensors, touch pad sensor, another touch-sensitive sensor, capacitive sensor, motion sensor, and switch. Likewise, the output components 207 of the internal components 200 may include one or more video, audio and/or mechanical outputs. For example, the output components 207 may include a video output component such as a cathode ray tube, liquid crystal display, plasma display, incandescent light, fluorescent light, front or rear projection display, and light emitting diode indicator. Of particular interest is a display having a touch-sensitive sensor corresponding to at least a portion of the display. Other examples of output components 207 include an audio output component such as a speaker, alarm and/or buzzer, and/or a mechanical output component such as vibrating or motion-based mechanisms.

The internal components 200 may further include a device interface 215 to provide a direct connection to auxiliary components or accessories for additional or enhanced functionality. In addition, the internal components 200 preferably include a power source 217, such as a portable battery, for providing power to the other internal components and allow portability of the portable electronic device 100.

It is to be understood that FIG. 2 is provided for illustrative purposes only and for illustrating components of a portable electronic device in accordance with the present invention, and is not intended to be a complete schematic diagram of the various components required for a portable electronic device. Therefore, a portable electronic device may include various other components not shown in FIG. 2, or may include a combination of two or more components or a division of a particular component into two or more separate components, and still be within the scope of the present invention.

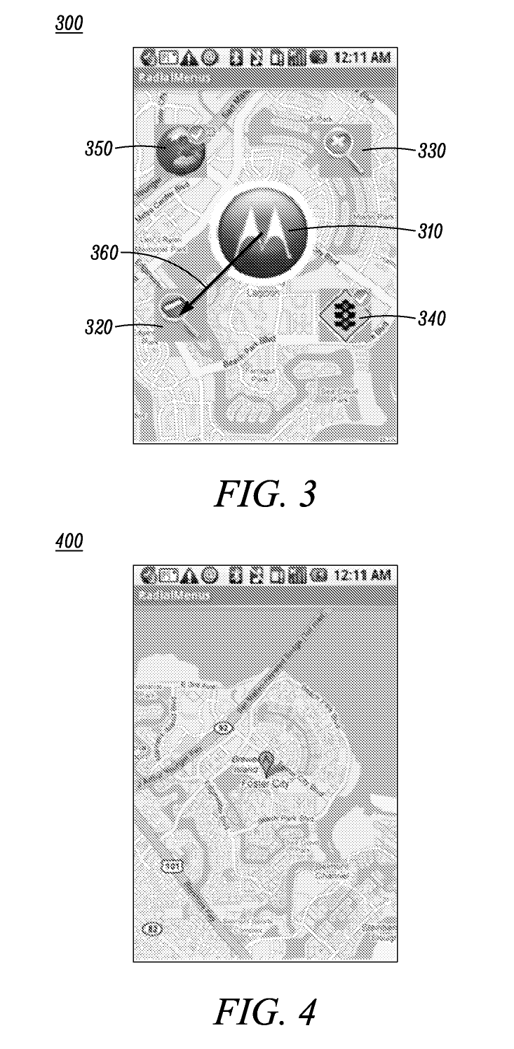

Referring to FIG. 3, there is shown a screen view 300 of a display of the portable electronic device illustrating a zoom out function. The screen view 300 may be provided any type of display for a portable electronic device. For example, the screen view 300 may correspond to the user interface shown in FIG. 1, which may include a touch-sensitive sensor overlaying a display 103. It should also be noted that, although FIGS. 3 through 10 illustrate use cases for a mapping application, the present invention is not restricted to mapping applications and may be applied to any type of application of a portable electronic device that may benefit from selection of transient menu options.

Initially, before any operation of the present invention, the application of the portable electronic device may have a default appears presented by the display. For example, for the mapping application shown in FIG. 3, a map of a particular location may be provided by the display. Then, upon detecting a first activation by the touch-sensitive sensor, i.e., contact from an object external to the device, the display may provide an activation image 310 and a plurality of transient menu options 320, 330, 340, 350 arranged radially from the activation image. In one embodiment, the activation image 310 may be provided at the contact point of the touch-sensitive sensor and the corresponding location of the display. For example, in the case where the user touches the lower right quadrant of the touch-sensitive sensor, the display may provide the activation image 310 at that lower right location and provide the transient menu options 320, 330, 340, 350 radially about that lower right location. For another embodiment, the activation image 310 may be provided at a default location, such as the center of the screen, regardless of the location where contact is detected by the touch-sensitive sensor.

As stated above, the transient menu options 320, 330, 340, 350 may be positioned radially about the activation image 310. In another embodiment, the transient menu options 320, 330, 340, 350 may be arranged radially and equidistant from the activation image 310. In yet another embodiment, the transient menu options 320, 330, 340, 350 may be arranged radially from the activation image 310 and distributed evenly about the activation image. For this embodiment, if the activation image 310 is positioned adjacent to an edge of the display such that transient menu options cannot be situated to one side of the activation image, then the transient menu options may be distributed evenly throughout the available areas of the display about the activation image 310.

Each transient menu option 320, 330, 340, 350 may correspond to a distinct device action, which is activated in response to detecting a second activation at the touch-sensitive sensor that corresponds to the particular transient menu option. The first activation of the touch-sensitive sensor corresponds to the activation image 310 of the display, and the second activation of the touch-sensitive sensor corresponds to the particular transient menu option 320, 330, 340, 350 of the display. For one embodiment, the second activation detected at the touch-sensitive sensor is preceded by continuous contact, as represented by movement direction 360, to the touch-sensitive sensor from the first activation to the second activation. For another embodiment, the second activation detected at the touch-sensitive sensor is preceded by linear contact, also represented by movement direction 360, to the touch-sensitive sensor between the first and second activations.

As shown in FIG. 3, the transient menu options may include a visual representation 320 of a zoom out or demagnification function of the portable electronic device. Thus, for example, if the user slides his or her finger along at least part of the path of movement direction 360 from the first activation corresponding to the activation image 310 to the second activation corresponding to the visual representation 320 of the zoom out function, then the mapping application performs the function of zooming out or demagnifying the view of the displayed image and removes the activation image and transient menu options from the display, as illustrated by FIG. 4.

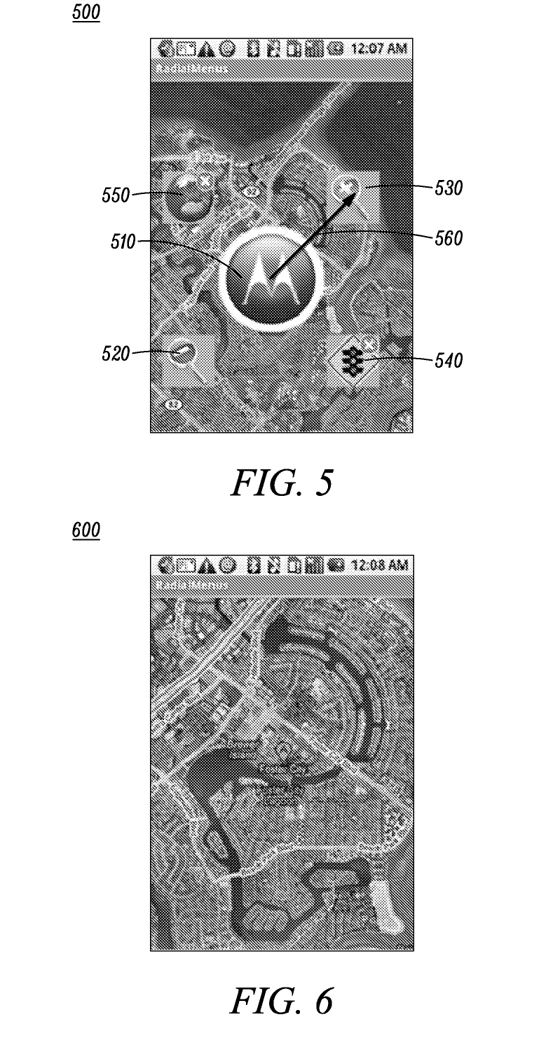

Referring to FIG. 5, there is shown a screen view 500 of the display of the portable electronic device illustrating a zoom in or magnification function. For this example, the transient menu options may include a visual representation 530 of the zoom in function of the portable electronic device. Thus, for example, if the user slides his or her finger along at least part of the path of movement direction 560 from the first activation corresponding to the activation image 510 to the second activation corresponding to the visual representation 530 of the zoom in function, then the mapping application performs the function of zooming in or magnifying the view of the displayed image and removes the activation image and transient menu options from the display, as illustrated by FIG. 6.

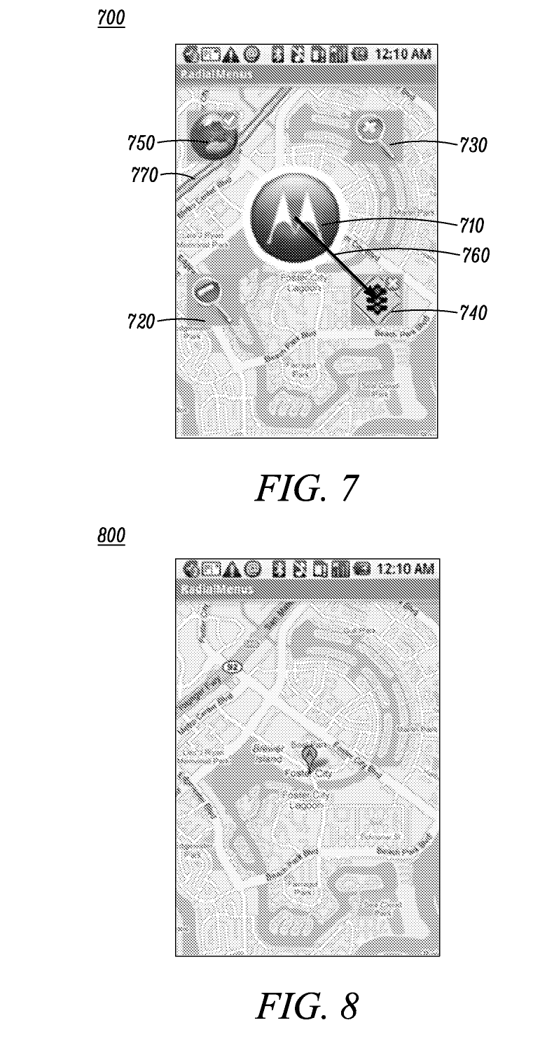

Referring to FIG. 7, there is shown a screen view 700 of the display of the portable electronic device illustrating a traffic off function. For this example, the transient menu options may include a visual representation 740 of the traffic function of the portable electronic device. Thus, for example, if the user slides his or her finger along movement direction 760 from the first activation corresponding to the activation image 710 to the second activation corresponding to the visual representation 740 of the traffic function, then the mapping application performs the function of removing lines or colors 770 indicating magnitude of traffic congestion from the view of the displayed image and also removes the activation image and transient menu options from the display, as illustrated by FIG. 6.

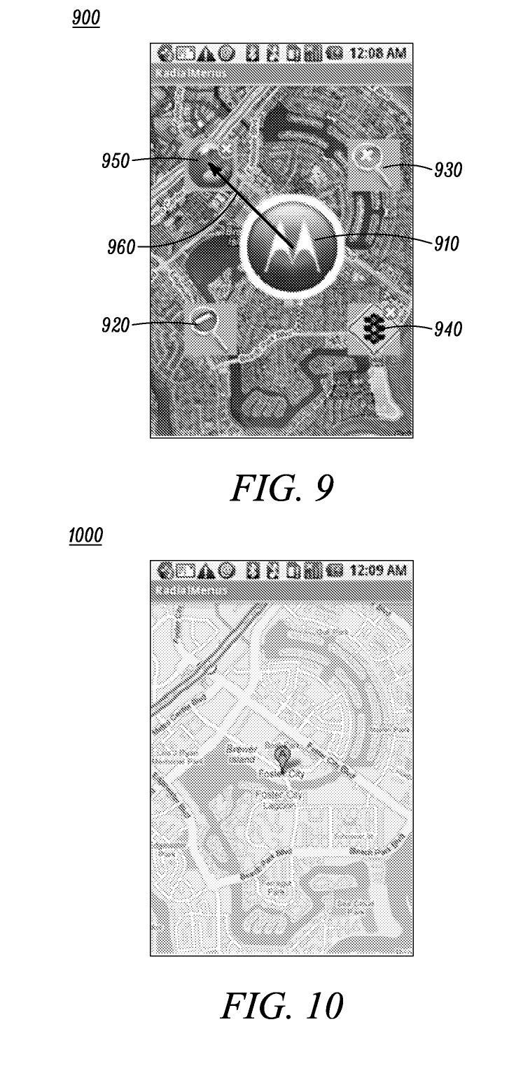

Referring to FIG. 9, there is shown a screen view 900 of the display of the portable electronic device illustrating a satellite off function. For this example, the transient menu options may include a visual representation 950 of a satellite function of the portable electronic device. Thus, for example, if the user slides his or her finger along movement direction 960 from the first activation corresponding to the activation image 910 to the second activation corresponding to the visual representation 950 of the satellite function, then the mapping application performs the function of changing the overall view of the displayed image from a satellite view to a graphical view, and removes the activation image and transient menu options from the display, as illustrated by FIG. 8

It should be noted that selection of transient menu options may toggle certain functions on-and-off or active-and-inactive. Each transient menu option may include multiple states and a visual indicator corresponding to each state. For example, the selection of the traffic function or the satellite function may change the state of the function from its current state to a new state, and vice versa.

Referring, by example, to the visual representations 750, 950 of the satellite function shown in FIGS. 7 and 9, the visual representations may provide a visual indicator to indicate a state of the particular function. The visual indicator may be presented visually by the display in the form of different foreground colors, background colors, fonts, styles, sizes, effects, and/or separate indicator overlapping or adjacent to the corresponding visual representation. For example, as illustrated FIG. 7, a visual indicator overlapping the upper right portion of the visual representation 750 may indicate that the function corresponding to the visual representation is on or active. Likewise, as illustrated in FIG. 9, a different visual indicator at the same upper right portion of the visual representation 750 may indicate that the function corresponding to the visual representation is off or inactive.

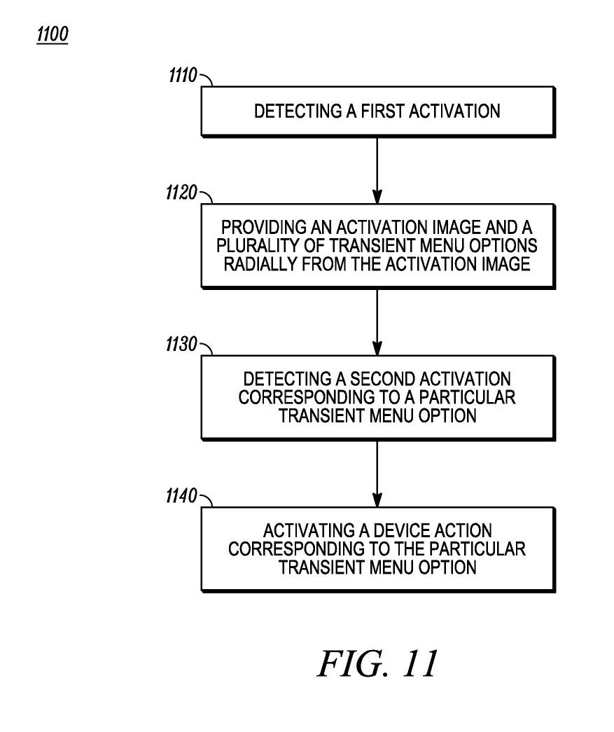

Referring to FIG. 11, there is shown a flow diagram of an operation 1100 of the portable electronic device in accordance with the present invention. The operation 1100 may be applicable for any type of portable electronic device, such as the devices described above. For example, the portable electronic device may have a display, a touch-sensitive sensor corresponding to at least a portion of the display, and a processor. For the operation 1100, the portable electronic device detects a first activation by the user at the touch-sensitive sensor at step 1110. In particular, the touch-sensitive sensor detects contact from an object external to the device, such as a finger of user or an object controlled by the user. Thus, the first activation corresponds to the contact point or location at the touch-sensitive sensor of the external object. Next, the display provides an activation image and more than one transient menu options radially from the activation image at step 1120. Examples of the activation image, transient menu options, and radially arrangement of the options are described above with respect to FIGS. 3 through 10. For one embodiment, the transient menu options may be arranged radially about the activation image. In another embodiment, in addition to being arranged radially about the activation image, the transient menu options may be arranged equidistant from the activation image and/or distributed evenly about the activation image.

Thereafter, the touch-sensitive sensor detects a second activation that corresponds to a particular transient menu option of the plurality of transient menu options at step 1130. Similar to the first activation, the touch-sensitive sensor detects contact from an object external to the device. Different from the first activation, the second activation corresponds to a location at the touch-sensitive sensor of a transient menu object distal from the first activation. For one embodiment, the touch-sensitive sensor may merely looks for the first and second activations. For another embodiment, the touch-sensitive sensor may look for continuous contact from the first activation to the second activation before detecting the second activation. For yet another embodiment, the touch-sensitive sensor may look for linear contact between the first and second activations before detecting the second activation. Finally, the processor activates a device action corresponding to the particular transient menu option at step 1140. Examples of the device actions are described above with respect to FIGS. 3 through 10.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A portable electronic device for gestural operation of context menus comprising:
a touch-sensitive sensor;
a display having the touch-sensitive sensor corresponding to at least a portion of the display, the display providing an activation image and a plurality of transient menu options arranged radially from the activation image in response to detecting a first activation at the touch-sensitive sensor, each transient menu option corresponding to a distinct device action; and
a processor coupled to the touch-sensitive sensor, the processor activating a device action corresponding to a particular transient menu option of the plurality of transient menu options in response to detecting a second activation at the touch-sensitive sensor that corresponds to the particular transient menu option.

2. The portable electronic device of claim 1, wherein the touch-sensitive sensor has a planar configuration and overlays at least a portion of the display.

3. The portable electronic device of claim 1, wherein the second activation detected at the touch-sensitive sensor is preceded by continuous contact to the touch-sensitive sensor from the first activation to the second activation.

4. The portable electronic device of claim 1, wherein the second activation detected at the touch-sensitive sensor is preceded by linear contact to the touch-sensitive sensor between the first and second activations.

5. The portable electronic device of claim 1, wherein the first activation of the touch-sensitive sensor corresponds to the activation image of the display, and the second activation of the touch-sensitive sensor corresponds to the particular transient menu option of the display.

6. The portable electronic device of claim 1, wherein the plurality of transient menu options are arranged equidistant from the activation image.

7. The portable electronic device of claim 1, wherein the plurality of transient menu options are distributed evenly about the activation image.

8. The portable electronic device of claim 1, wherein at least one transient menu option of the plurality of transient menu options may provide a visual indicator to indicate a state of the distinct device action corresponding to the at least one transient menu option.

9. The portable electronic device of claim 8, wherein the at least one transient menu option is associated with a single state among a plurality of possible states, and each state of the plurality of possible states corresponds to a different visual indicator.

10. A method of a portable electronic device for gestural operation of context menus, the portable electronic device having a display, a touch-sensitive sensor corresponding to at least a portion of the display, and a processor, the method comprising:
detecting, at the touch-sensitive sensor, a first activation;
providing, at the display, an activation image and a plurality of transient menu options radially from the activation image;
detecting, at the touch-sensitive sensor, a second activation that corresponds to a particular transient menu option of the plurality of transient menu options; and
activating, by the processor, a device action corresponding to the particular transient menu option.

11. The method of claim 10, further comprising detecting, at the touch-sensitive sensor, continuous contact from the first activation to the second activation before detecting the second activation.

12. The method of claim 10, further comprising detecting, at the touch-sensitive sensor, linear contact between the first and second activations before detecting the second activation.

13. The method of claim 10, wherein providing an activation image and a plurality of transient menu options radially from the activation image includes providing the plurality of transient menu options equidistant from the activation image.

14. The method of claim 10, wherein providing an activation image and a plurality of transient menu options radially from the activation image includes distributing the plurality of transient menu options evenly about the activation image.

15. The method of claim 10, wherein providing, at the display, an activation image and a plurality of transient menu options radially from the activation image comprises:
providing, at the display, a visual indicator corresponding to at least one transient menu option of the plurality of transient menu options to indicate a state of the device action corresponding to the at least one transient menu option.

16. The method of claim 15, further comprising providing, at the display, a second visual indicator corresponding to at least one transient menu option of the plurality of transient menu options to indicate a second state of the device action corresponding to the at least one transient menu option in response to detecting, at the touch-sensitive sensor, the second activation that corresponds to the particular transient menu option of the plurality of transient menu options.

17. The method of claim 15, further comprising providing, at the display, a second visual indicator corresponding to at least one transient menu option of the plurality of transient menu options to indicate a second state of the device action corresponding to the at least one transient menu option in response to activating, by the processor, the device action corresponding to the particular transient menu option.
